(19) United States
(12) Patent Application Publication
(10) Pub. No.: US 2007/0240212 A1
(43) Pub. Date: Oct. 11, 2007

(54) System and Methodology Protecting Against Key Logger Spyware

(75) Inventor: Siarhei Matalytski, Minsk (BY)

Correspondence Address: JOHN A. SMART, 708 BLOSSOM HILL RD., #201, LOS GATOS, CA, 95032, US

(73) Assignee: CHECK POINT SOFTWARE TECHNOLOGIES, INC., Redwood City, CA (US)

(21) Appl. No.: 11/308,506

(22) Filed: Mar. 30, 2006

(51) Int. Cl. G06F 12/14

(52) U.S. Cl. 726/22

(57) ABSTRACT

System and methodology protecting against key logger software (spyware) is described. In one embodiment, for example, a method is described for protecting a computer system from security breaches that include unauthorized logging of user input, the method comprises steps of: specifying a particular application to be protected from unauthorized logging of user input; identifying additional system processes that may serve as a source of unauthorized logging of user input; injecting into the particular application and each identified system process an engine capable of detecting and blocking attempts at unauthorized logging of user input; and upon detection of an attempt at unauthorized logging of user input, blocking the attempt so that user input for the particular application remains protected from unauthorized logging.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF INVENTION

1. Field of the Invention

The present invention relates generally to defending computer systems against security breaches and, more particularly, to defending such systems against key logger spyware and other security breaches.

2. Description of the Background Art

The first computers were largely stand-alone units with no direct connection to other computers or computer networks. Data exchanges between computers were mainly accomplished by exchanging magnetic or optical media such as floppy disks. Over time, more and more computers were connected to each other using Local Area Networks or “LANs”. In both cases, maintaining security and controlling what information a computer user could access was relatively simple because the overall computing environment was limited and clearly defined.

With the ever-increasing popularity of the Internet, however, more and more computers are connected to larger networks. Providing access to vast stores of information, the Internet is typically accessed by users through Web “browsers” (e.g., Microsoft® Internet Explorer or Netscape Navigator) or other Internet applications. Browsers and other Internet applications include the ability to access a URL (Uniform Resource Locator) or “Web” site. In the last several years, the Internet has become pervasive and is used not only by corporations, but also by a large number of small business and individual users for a wide range of purposes.

As more and more computers are now connected to the Internet, either directly (e.g., over a dial-up or broadband connection with an Internet Service Provider or “ISP”) or through a gateway between a LAN and the Internet, a whole new set of challenges face LAN administrators and individual users alike: these previously closed computing environments are now open to a worldwide network of computer systems. A particular set of challenges involves attacks by perpetrators (hackers) capable of damaging the local computer systems, misusing those systems, and/or stealing proprietary data and programs. The software industry has, in response, introduced a number of products and technologies to address and minimize these threats, including “firewalls”, proxy servers, and similar technologies—all designed to keep malicious users (e.g., hackers) from penetrating a computer system or corporate network. Firewalls are applications that intercept the data traffic at the gateway to a Wide Area Network (“WAN”) and check the data packets (i.e., Internet Protocol packets or “IP packets”) being exchanged for suspicious or unwanted activities.

Another security measure that has been utilized by many users is to install an end point security (or personal firewall) product on a computer system to control traffic into and out of the system. An end point security product can regulate all traffic into and out of a particular computer. One such product is assignee's ZoneAlarm® product that is described in detail in U.S. Pat. No. 5,987,611, the disclosure of which is hereby incorporated by reference. For example, an end point security product may permit specific “trusted” applications to access the Internet while denying access to other applications on a user's computer. To a large extent, restricting access to “trusted” applications is an effective security method. However, despite the effectiveness of end point security products, issues remain in protecting computer systems against attack by malicious users and applications.

Growth of Internet-based technologies has opened new opportunities for people: the way they work, operate their businesses, or organize their own personal life. Consider several typical examples:

1. Client connects from a home computer to a bank's network, for managing accounts and performing payments.

2. During holiday season, people buy gifts on-line and pay with their credit cards.

3. An employee on the business trip connects to corporate network via web-kiosk in order to check email.

Common in all these use cases is the requirement that personal or sensitive information be entered and sent over the Internet.

Such widespread use of Internet technologies has created opportunities not only for business, life, and entertainment but for criminals also. For example, the crime of “identity theft” is becoming increasingly prevalent. Identify theft occurs when someone steals personal information without permission to commit fraud or other crime. Examples of such personal information include corporate login and password, Social Security Number (SSN), credit card number, or the like. SSL (Secure Socket Layer) based technologies can be used to protect personal data that travels over networks. Similar technologies for authentication and encryption have emerged, such as RSA SecurID. Although such technologies protect sensitive information while it travels over a network, the weakest link or vulnerability in the above example scenarios occurs not during network transmission, but at end-point computers such as web kiosks and home computers.

One particular problem that remains is how to secure computers that receive sensitive user input, such as via keyboard and mouse input devices. These input devices, which are connected to computers having access to the Internet, are vulnerable to security breaches or attacks, such as “sniffing” or “key logging.” For example, malicious “key logger” software may be installed at an end-point computer to record user's keystrokes, looking for user names and passwords, and other sensitive information. Recently in New York, for example, an individual plead guilty in federal court to two counts of computer fraud and one charge of unauthorized possession of access codes for a scheme in which the individual planted a copy of a commercial keyboard sniffing program on computers at a well-known copy service firm. Using his makeshift surveillance mechanism, the individual captured over 450 on-line banking passwords and user names from unsuspecting customers. He then used the victims' financial information to open new accounts under their names, and then siphon money from their legitimate accounts into the new, fraudulent ones. Apart from the criminal activities of the individual, the copy service firm itself is potentially open to liability for failure to adequately protect its equipment from such activities. Key loggers can easily be installed using exploits in operating system or web browsers, along with other software like games or P2P clients; additionally, individuals that have access to user's computers can install them by intention, as in the case of the foregoing incident. Given the increasing popularity of Internet cafes, the risk for this type of fraud can be expected to grow.

Today, different approaches have attempted to address the key logger problems. These include traffic scanners, signature based scanners, heuristics, and virtualization. Each will be discussed in turn. For the purposes of the discussion which follows, unwanted or malicious software, such as key loggers, will be referred to generally using the term of “spyware.” Spyware refers to software that spies on the user's computer and tries to gather personal information. Of particular interest is spyware that attempts to gather such information for unauthorized purposes (e.g., illegal activities), as opposed to other unauthorized software that gathers user metrics merely for advertising or banner use.

Traffic scanners analyze all outgoing traffic from the end-point PC, and check whether private information is being sent via the network. In the case that a network payload with private information is detected, that traffic can be blocked, or optionally the user may be asked to confirm that it is indeed an authorized transmission. An extension to this approach is to scan user keystrokes and check with a database for the private information.

Signature-based scanners represent an approach that is similar to many anti-virus or anti-spyware products. The approach employs a database (“definition file”) with key logger signatures. Signatures may include (but are not limited to): registry keys, file names and sizes, and md5 checksums.

Heuristic-based approaches attempt to identify common behavior of spyware and calculate a probability representing whether the software (under inspection) is good or bad. The following parameters can be analyzed:

Network activity: detection of software that tries to create a (communication) socket, send information over network, and/or open listening ports.

System API usage: detection of software that installs hooks, tries to patch or replace system libraries, installs device drivers, or tries to access system registry keys that normal application do not access.

Code disassembly: disassembling software program code and analyzing it to detect malicious behavior.

Other suspicious activity that can be considered malicious: detection of software that attempts to download and install executable (program) from a web site, tries to change browser's home page, and/or tries to inject itself into a system process.

After the analysis, all good activity and all bad activity is weighted and summarized, and a final conclusion about the program is drawn.

Virtualization employs a “sandbox” for achieving computer security. A sandbox is a security mechanism for safely running programs. It is often used to execute untested code, or programs from unverified third parties and not-trusted users. For example, Java applets employ a Java sandbox for execution; these applications are executed in a separate (virtual) context. With regards to protection of end-point PCs from key loggers and other spyware, virtualization can be used to provide a sandbox for every application on the end-point PC, thus preventing a key logger in the sandbox from spying on other applications. Virtualization can also provide safe context (i.e., a sterile environment) for the exclusive use by separately-selected applications only. For example, a secure web browser that connects to a company portal may execute in a virtual sandbox environment, which excludes all other applications.

Although the threats posed by spyware is now widely recognized, the solutions offered to date have significant shortcomings. Traffic scanners are built into many modern products. Unfortunately, they provide only basic protection and are oriented mostly to preventing user mistakes (e.g., preventing a user from inadvertently disclosing his or her user password when asked via instant messengers). This protection can be easily bypassed by Trojan horse programs (“trojans”) or key loggers, by simply encrypting or obfuscating network traffic.

Signature-based scanners are in wide use today, with practically every modern anti-virus or anti-spyware product including a signature-based scan engine. This solution works for popular (i.e., well known, well characterized) viruses, trojans, and key loggers. However, two serious drawbacks remain. First, protection is not instantaneous (i.e., it does not occur in real time). For example, it can take several hours to analyze a new threat and produce a fix (e.g., updated definition file). Often it is too late, the damage is already done. Second, the approach does not protect from customizable software. A malicious user can easily customize key loggers using special tools (i.e., obfuscate its signature), so they will not be detected by scan engines.

Similar to signature-based scan engines, modern heuristic-based engines provide very good results. They are able to detect a rather large number of spyware. However, heuristic-based approaches are susceptible to false positives—that is, a valid program can be mistakenly detected to be spyware. Additionally, spyware can be adapted to attack specific heuristic algorithms that are used for detection. More sophisticated spyware often can bypass such engines.

Although virtualization technique appears to be a promising technology to fight spyware, it also has significant drawbacks. Perhaps the biggest drawback is that the approach provides an awkward user experience, thus impending computer system usability. Users are simply not used to transferring data from secured context (virtualization “sandbox”) to desktop (and vice versa). Users also have difficulty setting up communication between a program operating in a virtual environment with one operating on an unsecured desktop. Similarly, installation and deployment of a virtualization solution typically are difficult tasks, requiring high (superuser) privileges, or installation of device driver, and the like.

Although the threat posed by spyware is now widely recognized, solutions offered to date have each suffered from shortcomings that prevent widespread deployment. Accordingly, a better solution is sought.

### SUMMARY OF INVENTION

System and methodology protecting against key logger software (spyware) is described. In one embodiment, for example, a method of the present invention is described for protecting a computer system from security breaches that include unauthorized logging of user input, the method comprises steps of: specifying a particular application to be protected from unauthorized logging of user input; identifying additional system processes that may serve as a source of unauthorized logging of user input; injecting into the particular application and each identified system process an engine capable of detecting and blocking attempts at unauthorized logging of user input; and upon detection of an attempt at unauthorized logging of user input, blocking the attempt so that user input for the particular application remains protected from unauthorized logging.

In another embodiment, for example, a system of the present invention for protecting a computer from unauthorized logging of user input is described that comprises: application software that is desired to be protected from unauthorized logging of user input; a first module for protecting the application software from unauthorized logging of user input, wherein the first module blocks attempts at unauthorized logging from processes that run on the computer system in user mode; and a second module for blocking attempts at unauthorized logging from processes running in kernel mode.

In yet another embodiment, for example, in a computer system, an improved method of the present invention is described for preventing theft of sensitive information, the method comprises steps of: authorizing a process running on the computer system to receive sensitive information provided via user input; trapping user input events occurring on the computer system before they are reported to processes running on the computer system; allowing the user input events to be passed through to the authorized process; and masking the user input events from other processes running on the computer system that have not been authorized.

In another embodiment, for example, an anti-key logging system of the present invention is described for preventing unauthorized logging of user input from a computer, the anti-key logging system comprises: program logic for intercepting user input events occurring on the computer before such events are reported to processes running on the computer; program logic for reporting the user input events to a process specifically authorized to receive the user input events; and program logic for blocking the user input events from other processes running on the computer that have not been authorized.

### BRIEF DESCRIPTION OF DRAWINGS

FIG. 1 is a very general block diagram of a computer system (e.g., an IBM-compatible system) in which software-implemented processes of the present invention may be embodied.

FIG. 2 is a high-level block diagram of an anti-key logger (AKL) system of the present invention, as it operates in a runtime environment.

FIG. 3 is a block diagram illustrating a runtime environment in which the anti-key logger system of the present invention provides protection.

FIG. 4 (A and B) is a flowchart illustrating a method of the present invention for enabling protection.

FIG. 5 is a flowchart illustrating a method of the present invention for dropping or de-initializing protection.

### DETAILED DESCRIPTION

Glossary

The following definitions are offered for purposes of illustration, not limitation, in order to assist with understanding the discussion that follows.

End point security: End point security is a way of managing and enforcing security on each computer instead of relying upon a remote firewall or a remote gateway to provide security for the local machine or environment. End point security involves a security agent that resides locally on each machine. This agent monitors and controls the interaction of the local machine with other machines and devices that are connected on a LAN or a larger wide area network (WAN), such as the Internet, in order to provide security to the machine.

Firewall: A firewall is a set of related programs, typically located at a network gateway server, that protects the resources of a private network from other networks by controlling access into and out of the private network. (The term also implies the security policy that is used with the programs.) A firewall, working closely with a router program, examines each network packet to determine whether to forward it toward its destination. A firewall may also include or work with a proxy server that makes network requests on behalf of users. A firewall is often installed in a specially designated computer separate from the rest of the network so that no incoming request directly accesses private network resources.

Kernel mode: Kernel mode is a memory-protection mode of execution (e.g., under Microsoft Windows operating system) that grants access to all system memory and all the processor's instructions. For example, system services enumerated in the System Service Descriptor Table (SSDT) run in kernel mode. Third party device drivers also run in kernel mode because they must access low level kernel functions and objects and interface with hardware in many cases.

MD5: MD5 is a message-digest algorithm which takes as input a message of arbitrary length and produces as output a 128-bit “fingerprint” or “message digest” of the input. The MD5 algorithm is used primarily in digital signature applications, where a large file must be “compressed” in a secure manner before being encrypted with a private (secret) key under a public-key cryptosystem. Further description of MD5 is available in “RFC 1321: The MD5 Message-Digest Algorithm”, (April 1992), the disclosure of which is hereby incorporated by reference. A copy of RFC 1321 is available via the Internet (e.g., currently at www.ietf.org/rfc/rfc1321.txt).

Network: A network is a group of two or more systems linked together. There are many types of computer networks, including local area networks (LANs), virtual private networks (VPNs), metropolitan area networks (MANs), campus area networks (CANs), and wide area networks (WANs) including the Internet. As used herein, the term “network” refers broadly to any group of two or more computer systems or devices that are linked together from time to time (or permanently).

Portal: A portal provides an individualized or personalized view of multiple resources (e.g., Web sites) and services. A portal typically offers a single access point (e.g., browser page) providing access to a range of information and applications. A portal assembles information from a number of different sources (e.g., Web sites and applications) enabling a user to quickly receive information without having to navigate to a number of different Web sites. A portal also typically enables a user to obtain a personalized view of information and applications by organizing and grouping information and services for presentation to users.

RSA: The RSA cryptosystem is a public-key cryptosystem that offers both encryption and digital signatures (authentication). Ronald Rivest, Adi Shamir, and Leonard Adleman developed the RSA system in 1977. RSA stands for the first letter in each of its inventors' last names.

SSL: SSL is an abbreviation for Secure Sockets Layer, a protocol developed by Netscape for transmitting private documents over the Internet. SSL works by using a public key to encrypt data that is transferred over the SSL connection. Both Netscape Navigator and Microsoft Internet Explorer support SSL, and many Web sites use the protocol to obtain confidential user information, such as credit card numbers. SSL creates a secure connection between a client and a server, over which data can be sent securely. For further information, see e.g., “The SSL Protocol, version 3.0”, (Nov. 18, 1996), from the IETF, the disclosure of which is hereby incorporated by reference. See also, e.g., “RFC 2246: The TLS Protocol, version 1.0”, available from the IETF. A copy of RFC 2246 is available via the Internet (e.g., currently at www.itef.org/rfc/rfc2246.txt).

TCP: TCP stands for Transmission Control Protocol. TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent. For an introduction to TCP, see e.g., “RFC 793: Transmission Control Program DARPA Internet Program Protocol Specification”, the disclosure of which is hereby incorporated by reference. A copy of RFC 793 is available via the Internet (e.g., currently at www.ietf.org/rfc/rfc793.txt).

TCP/IP: TCP/IP stands for Transmission Control Protocol/Internet Protocol, the suite of communications protocols used to connect hosts on the Internet. TCP/IP uses several protocols, the two main ones being TCP and IP. TCP/IP is built into the UNIX operating system and is used by the Internet, making it the de facto standard for transmitting data over networks. For an introduction to TCP/IP, see e.g., “RFC 1180: A TCP/IP Tutorial”, the disclosure of which is hereby incorporated by reference. A copy of RFC 1180 is available via the Internet (e.g., currently at www.ietf.org/rfc/rfc1180.txt).

Thread: A thread refers to a single sequential flow of control within a program. Operating systems that support multi-threading enable programmers to design programs whose threaded parts can execute concurrently. In some systems, there is a one-to-one relationship between the task and the program, but a multi-threaded system allows a program to be divided into multiple tasks. Multi-threaded programs may have several threads running through different code paths simultaneously.

URL: URL is an abbreviation of Uniform Resource Locator, the global address of documents and other resources on the World Wide Web. The first part of the address indicates what protocol to use, and the second part specifies the IP address or the domain name where the resource is located.

User mode: User mode (“userspace”) is a memory-protection mode of execution (e.g., under Microsoft Windows) that application software runs under. User mode processes are unprivileged.

Introduction

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

Computer-Based Implementation

Basic System Hardware and Software (E.G., for Desktop and Server Computers)

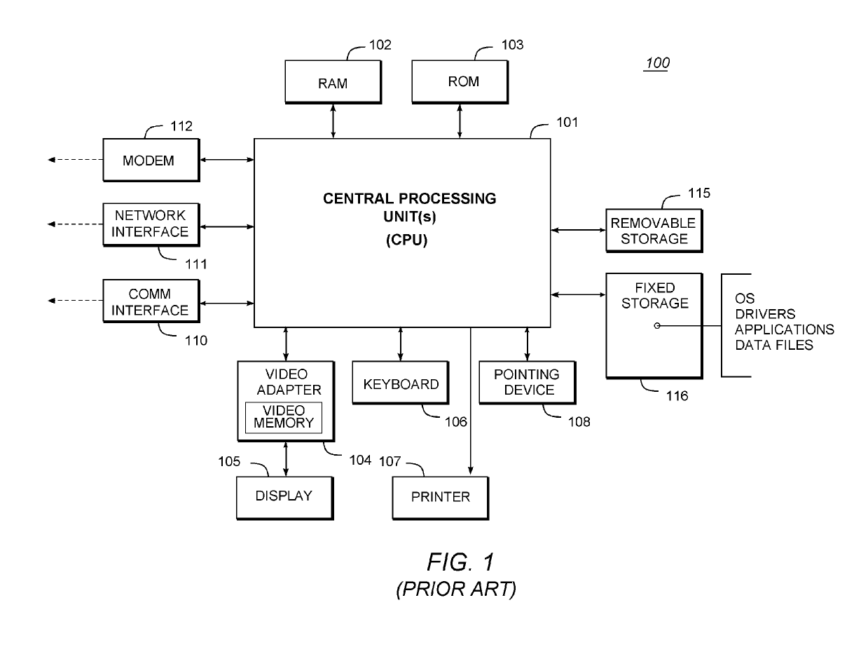

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP Laserjet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, Microsoft Windows NT, Microsoft Windows 2000, Microsoft Windows XP, or Microsoft Windows Vista (Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

The above-described computer hardware and software are presented for purposes of illustrating the basic underlying computer components that may be employed for implementing the present invention. For purposes of discussion, the following description will present examples in which it will be assumed that there exists at least one computer, for example, a “client” or end-user computer (e.g., desktop computer). The present invention, however, is not limited to any particular type of computer or particular type of environment. Instead, the present invention may be implemented in any type of system architecture or processing environment capable of supporting the methodologies of the present invention presented in detail below.

OS Privilege Modes and Windows Subsystems

In order to understand aspects of the present invention discussed below, it is helpful to first review the privilege modes of a modern-day operating system, such as Microsoft Windows. During use, an operating system's kernel must be protected from user applications, but user applications require certain functionality from the kernel. To provide this in Windows, for example, the Windows operating system implements two modes of execution: user mode and kernel mode. Intel and AMD CPUs actually support four privilege modes or rings in their chips to protect system code and data from being overwritten maliciously or inadvertently by code of a lesser privilege. Kernel mode refers to a mode of execution in a processor that grants access to all system memory and all the processor's instructions. For example, system services enumerated in Windows' Service Descriptor Table (SDT) run in kernel mode. Third party device drivers also run in kernel mode because they must access low-level kernel functions and objects, and interface with hardware in many cases. Application software, on the other hand, runs in user mode (“user space”). User mode processes are unprivileged. Windows will tag pages of memory specifying which mode is required to access the memory, but Windows does not protect memory in kernel mode from other threads running in kernel mode.

Microsoft Windows itself is implemented as a set of subsystems: the Win32 subsystem, the POSIX subsystem, and the OS/2 subsystem. Each subsystem provides a library of services and is implemented as a Dynamic Link Library (DLL). These subsystems provide an interface to the system services that reside in kernel memory. By using Windows' application programming interface (API), application developers can write software that invokes services provided by the Windows operating system (e.g., graphical user interface (GUI) services). Usually, application software requests services by invoking one of these subsystems (i.e., DLL). Each library (DLL) exports the documented interface (i.e., application programming interface) for that subsystem. The “Win32 subsystem” is the most commonly used. It includes Kernel32.dll, User32.dll, Gdi32.dll, and Advapi32.dll. Ntdll.dll is a special system support library that the subsystem DLLs use. It provides dispatch stubs to Windows executive system services, which ultimately pass control to the SDT in the kernel where the real work is performed. These stubs contain architecture specific code that causes a transition into kernel mode.

Providing Anti-Key Logger Protection

In accordance with the present invention, an anti-key logger system and associated methodologies are provided which incorporate the following design features:

Protect sensitive session information entered with keyboard while the secure (protected) session is active, and disable protection after the session is finished.

Enable protection only for an application that is involved in a secure session (e.g., browser which communicates with protected portal).

Enable protection both in user space and kernel mode to protect against all types of key loggers.

Monitor process creation during the secure session, so all newly started key loggers will be automatically disabled.

Detailed implementation and use of these features are described below.

System Components

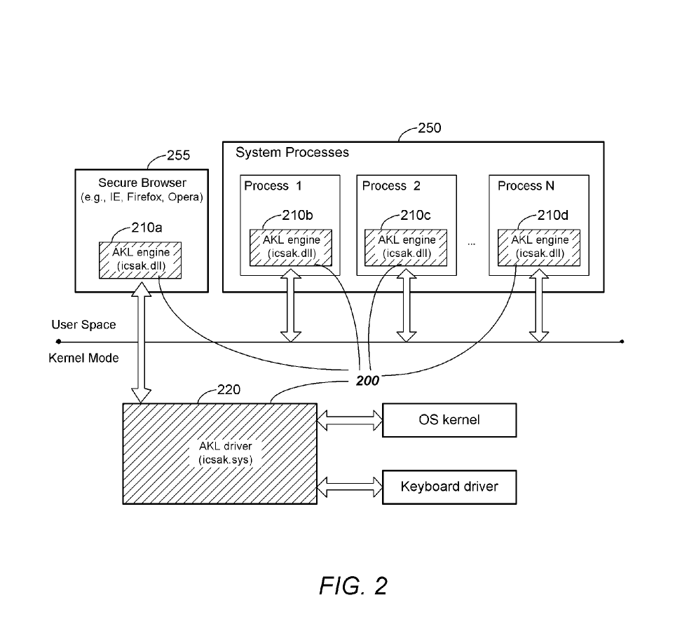

FIG. 2 is a high-level block diagram of an anti-key logger (AKL) system 200 of the present invention, as it operates in a runtime environment. The AKL system 200, whose constituent components are shown in shading in FIG. 2, works on the client side (e.g., end-point computer) to prevent the user's confidential information entered with keyboard from being logged. The AKL system 200 blocks system application program interfaces (API) that are used by key loggers during the time of secure session. The anti-key logger functionality of the system is active only when current input focus is set to the protected application (i.e., application protected by the AKL system). In the primary usage (i.e., most common) case, the protected application is a browser that communicates with a protected portal. When the corresponding secure session is terminated, the system 200 unloads all its components.

As shown, the AKS system 200 includes the following main components (shown with shading):

(1) Anti-key logger (AKL) engine 210 (icsak.dll): an anti-key logger engine and protection module, which protects against user-mode keyloggers.

(2) Anti-key logger (AKL) driver 220 (icsak.sys): an anti-key logger driver, which serves as a protection module protecting against kernel-mode keyloggers.

In the currently preferred embodiment, the AKL engine 210 (icsak.dll) is implemented as a dynamic link library (e.g., Windows .DLL file). During initialization, the AKL engine 210 injects its main module (icsak.dll) into each process running on the host, thereby enabling protection against user-mode key loggers. Then it installs and loads the AKL driver 220 (icsak.sys), thereby enabling protection against kernel-mode key loggers. As shown in the figure, the engine is effectively injected into every running process (i.e., protected application(s) and system processes running in user space), thus creating multiple engine instances during typical operation. For example, the processes shown executing within secure browser 255 and system processes 250 (i.e., Process 1, Process 2, and Process N) each includes an injected engine 210 (i.e., engine 210a, 210b, 210c, 210d, respectively). The aim is not to inject the AKL engine into all processes running on the end point, but instead to inject the AKL engine into those running processes on the end point (e.g., one application (secured browser 255) plus system processes 250) that are required to block potential user space key loggers for a particular application(s) (e.g., secured browser 255).

In operation, the AKL engine 210 (icsak.dll) blocks user space API calls that are used by key loggers to grab keyboard input. It also monitors process creation operations and injects itself into all newly-created processes. This ensures that even if a key logger is started after protection is enabled, it will also be disabled. The AKL driver 220 (icsak.sys), on the other hand, provides an interface (API services) to bypass kernel-mode key loggers. This API is used by a protected process only (e.g., Web browser requiring protection). All other processes remain untouched, left to work through default system API. The input of unprotected processes is visible to key loggers.

In order to interface with client processes (i.e., applications that desire protection against key loggers), the engine exposes the following public application programming interfaces (APIs), shown in pseudocode (i.e., without parameter information):

STATUS EnableProtection( );

STATUS DisableProtection( );

The name of each API describes the functionality provided. The EnableProtection API call enables protection for an application to be protected (“protected application”). Protection is dropped by invoking the DisableProtection API call, which disables protection. In use, the AKL engine 210 (icsak.dll) is loaded by software (e.g., third-party application software) that seeks protection from key loggers. Upon loading the engine into its own context (i.e., memory space), a given application proceeds to invoke the EnableProtection API call, whereupon the engine proceeds to protect the application against key loggers.

Detailed Operation

The following description presents method steps that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server).

Anti-Key Logger Initialization and Workflow

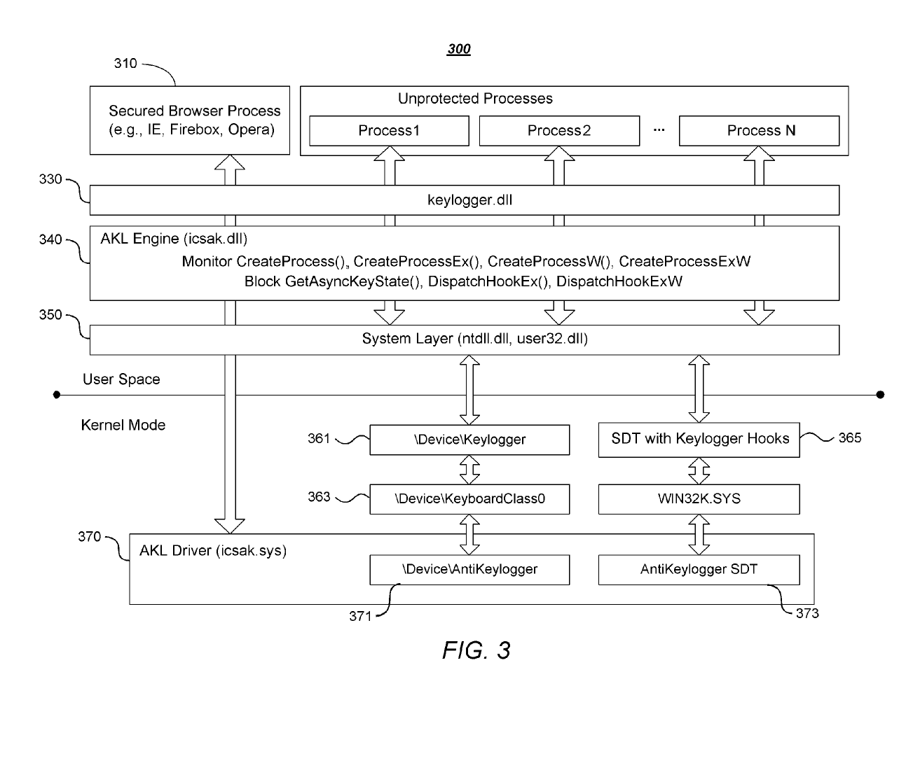

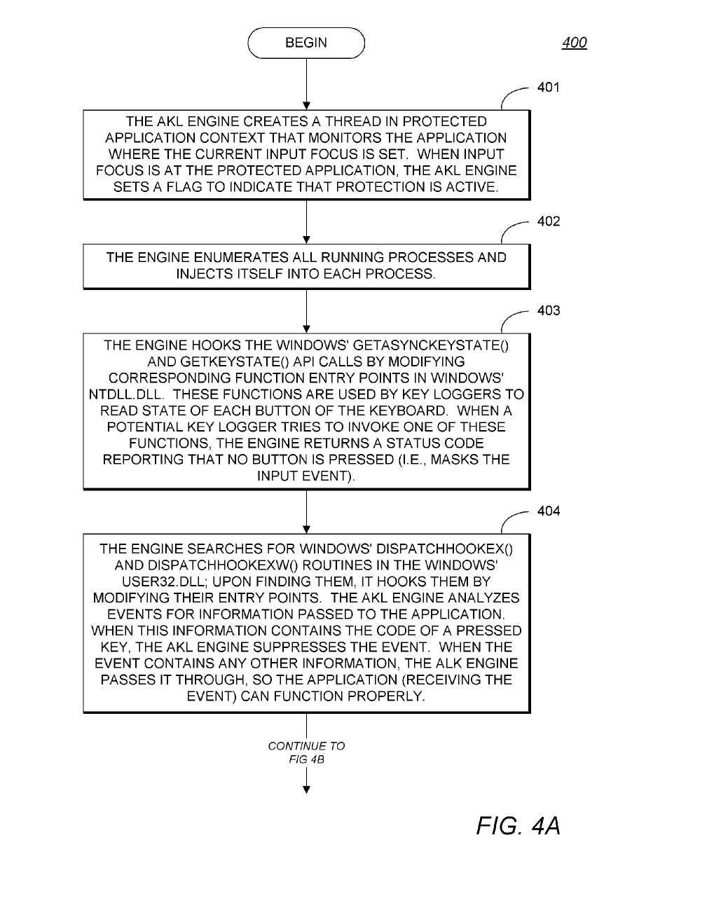

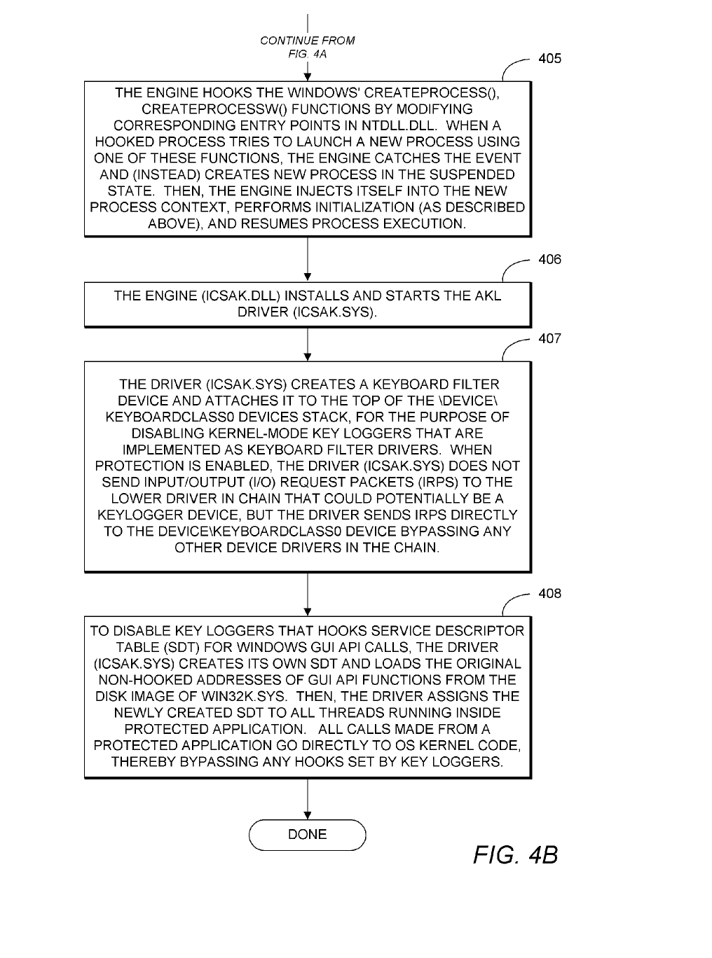

FIG. 3 is a block diagram illustrating a runtime environment 300 in which the anti-key logger system of the present invention provides protection. FIG. 4 (A and B) is a flowchart illustrating a method 400 of the present invention for enabling protection. The flowchart in FIG. 4 is discussed below in conjunction with the block diagram of FIG. 3.

When the EnableProtection( ) API call is invoked, the AKL engine 340 performs the following method steps. At step 401, the AKL engine 340 creates a thread in protected application context that monitors the application (e.g., secured browser process 310) where the current input focus is set. When input focus is at the protected application, the AKL engine 340 sets a flag to indicate that protection is active. This flag is accessible for both the engine 340 and driver 370 modules. At step 402, the engine 340 enumerates all running processes and injects itself into each process.

The next three steps are performed by the AKL engine 340 in the context (i.e., memory space) of each process (e.g., process 310). At step 403, the engine hooks the Windows GetAsyncKeyState( ) and GetKeyState( ) API calls by modifying corresponding function entry points in Windows ntdll.dll (system layer 350). These functions are used by key loggers (e.g., keylogger.dll 330) to read the state of each button of the keyboard. When a potential key logger tries to invoke one of these functions, the engine 340 returns a status code reporting that no button is pressed (i.e., masks the input event). At step 404, the engine 340 searches for Windows' DispatchHookEx( ) and DispatchHookExW( ) routines in the Windows' user32.dll (system layer 350); upon finding them, it hooks them by modifying their entry points. These Windows API functions are not exportable, so the search is therefore done using code signatures. The Windows OS kernel invokes these functions to pass information to application hooks set with the Windows' SetWindowsHookEx( ) API call. The AKL engine 340 catches this event and analyzes information passed to the application. When this information contains the code of a pressed key, the AKL engine 340 suppresses the event. When the event contains any other information, the ALK engine 340 passes it through (i.e., original or “pass-thru” way) so the application (intended recipient of the event) can function properly. At step 405, the engine 340 hooks the Windows' CreateProcess( ), CreateProcessW( ) functions by modifying corresponding entry points in ntdll.dll (system layer 350). When a hooked process tries to launch a new process using one of these functions, the engine 340 catches the event and (instead) creates the new process in a suspended state. Then, the engine 340 injects itself into the new process context, performs initialization as described above (and in further detail below), and resumes process execution.

At step 406, the engine 340 (icsak.dll) installs and starts the AKL driver 370 (icsak.sys). At step 407, the driver 370 creates a keyboard filter device 371 and attaches it to the top of the \Device\KeyboardClass0 363 devices stack, for the purpose of disabling kernel-mode key loggers that are implemented as keyboard filter drivers. Without protection enabled, input/output (I/O) request packets (IRPs) go the lower driver in the chain, which could potentially be a key logger device. When protection is enabled, however, the driver sends IRPs directly to the \Device\KeyboardClass0 device bypassing any other device drivers in the chain. As a result, any key logger device (e.g., device 361) will not be able to see request packets and keyboard driver replies (i.e., code of pressed button).

At step 408, to disable key loggers that hooks service descriptor table (SDT) for Windows GUI API calls, the driver 370 creates its own SDT (anti-key logger SDT 373) and loads the original non-hooked addresses of GUI API functions from the disk image of WIN32K.SYS. Then, the driver 370 assigns the newly created SDT 373 to all threads running inside the protected application. As a result, all calls made from a protected application go directly to OS kernel code, thereby bypassing any hooks set by key loggers (e.g., key logger hooks 365).

Anti-Key Logger De-Initialization

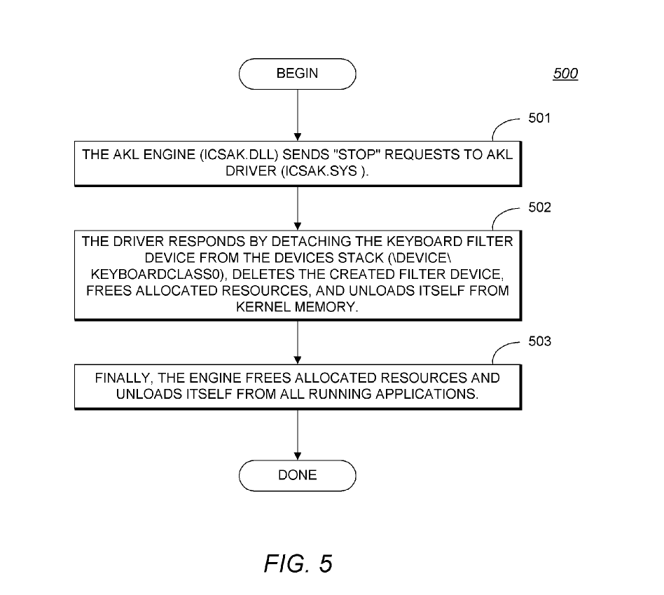

FIG. 5 is a flowchart illustrating a method 500 of the present invention for dropping or de-initializing protection. When the DisableProtection( ) API call is invoked, the method performs the following steps. At step 501, the AKL engine 340 sends “stop” requests to the AKL driver 370. At step 502, the driver 370 responds by detaching the keyboard filter device (device 371) from the devices stack (\Device\KeyboardClass0) 363, deletes the created filter device, frees allocated resources, and unloads itself from kernel memory. Finally, at step 503, the engine frees allocated resources and unloads itself from all running applications.

Exemplary Source Code Implementation

Blocking Keyboard Filters

The driver blocks keyboard filters, thus allowing the driver to bypass any keyboard filters installed by key loggers. This is done by creating an additional keyboard filter device and attaching it to the top of the device drivers stack for the keyboard driver. Since the anti-key logger device (i.e., device 371) seats on the top, it receives input/output request packets first in the chain. When protection is enabled, the anti-key logger device 371 sends received packets directly to the keyboard driver device bypassing any other devices in the chain (e.g., bypassing key logger device 361). The following illustrates the program code logic for this functionality, shown in pseudocode (abridged C):

1: typedef struct
2: {
3: PDEVICE_OBJECT next;
4: PDEVICE_OBJECT root_device;
5: }
6: DEVICE_EXTENSION, *PDEVICE_EXTENSION;
7:
8: NTSTATUS DriverDispatch(PDEVICE_OBJECT DeviceObject,
PIRP Irp)
9: {
10: PDEVICE_EXTENSION ext =
(PDEVICE_EXTENSION)DeviceObject−>DeviceExtension;
11: IoSkipCurrentIrpStackLocation(Irp);
12: if (ProtectionEnabled( ))
13: {
14: // protection enabled, call keyboard driver skipping all
other filters in chain
15: return IoCallDriver(ext−>root_device, Irp);
16: }
17: else
18: {
19: // protection disabled, call next filter in chain
20: return IoCallDriver(ext−>next, Irp);
21: }
22: }
23:
24: NTSTATUS DriverEntry(PDRIVER_OBJECT pDriverObject,
PUNICODE_STRINGpRegistryPath)
25: {
26: ANSI_STRING DriverName;
27: UNICODE_STRING upath;
28: NTSTATUS status = STATUS_SUCCESS;
29: PFILE_OBJECT pfo = NULL;
30: PDEVICE_OBJECT last_device = NULL;
31: PDEVICE_OBJECT root_device = NULL;
32: ULONG i;
33: PDEVICE_EXTENSION ext = NULL;
34:
35: RtlInitUnicodeString(&upath, L“\\Device\\KeyboardClass0”);
36:
37: // get keyboard driver device
38: status = IoGetDeviceObjectPointer(&upath, FILE_ALL_ACCESS,
&pfo, &last_device);
39: root_device = IoGetBaseFileSystemDeviceObject(pfo);
40:
41: // create our own keyboard filter device
42: status = IoCreateDevice(
43: pDriverObject,
44: sizeof(DEVICE_EXTENSION),
45: NULL,
46: last_device−>DeviceType,
47: 0,
48: FALSE,
49: &hook_dev
50: );
51: hook_dev−>Flags |= DO_BUFFERED_IO;
52:
53: for (i = 0; i <= IRP_MJ_MAXIMUM_FUNCTION; i++)
54: pDriverObject−>MajorFunction[i] = DriverDispatch;
55:
56: // attach to the top of the keyboard device drivers stack
57: ext = hook_dev−>DeviceExtension;
58: ext−>root_device = root_device;
59: ext−>next = IoAttachDeviceToDeviceStack(hook_dev,
last_device);
60:
61: return STATUS_SUCCESS;
62: }

DEVICE_EXTENSION (lines 1-6) is an internal structure for storing local variables. The structure is employed for passing variables (i.e., next device in the drivers stack chain and root device in the drivers stack) to DriverDispatch. In the DriverDispatch function (beginning at line 8), the function determines if protection is enabled (line 12). If “true,” then the function calls the keyboard driver, thereby skipping all other filters in the chain. In this manner, the anti-key logger device (installed by the system of the present invention) sends received packets directly to the keyboard driver device bypassing any other devices in the chain. Otherwise (i.e., “else” or “protection disabled” case, at line 17), the function calls the next filter in the chain of device objects (line 20).

The process of the anti-key logger device creating its own filter that sits on top of the device stack is accomplished by the DriverEntry function (definition beginning at line 24). After getting the address (pointer) to the keyboard object device (pfo, at line 38), the function creates its own keyboard filter device (lines 41-50). The function attaches the filter to the top of the keyboard device drivers stack (lines 56-59). As the filter is placed on the top of the keyboard device drivers stack, it can be easily removed from the stack (i.e., without losing any sense).

Blocking Key Loggers Use of Windows Hooks (SetWindowsHookEx( ) Windows API Call)

The present invention includes a SetWindowsHookEx( ) API call blocker that provides a mechanism to block key loggers that use user space hooks. To set a hook (Windows hook) for receiving keyboard input, a malicious key logger invokes this Windows API function call and passes the address of the routine (i.e., registers a callback routine) to be called whenever a keyboard event occurs. Callback is done by the Windows OS kernel using the Windows DispatchHookEx( )/DispatchHookExW( ) routines in the Windows USER32.DLL code. The anti-key logger system of the present invention prevents this malicious activity by hooking the dispatch routines and filtering events that can be delivered to applications. If protection is enabled and an event occurs that contains information about pressed buttons, the anti-key logger system suppresses the event; thus the event is not reported to the application. The Windows DispatchHookEx( )/DispatchHookExW( ) routines are not exportable from the Windows USER32.DLL. Therefore, the anti-key logger system searches for them in the address space of USER32.DLL using special code signatures. This is done in the context of each running process. Exemplary program logic for this functionality is illustrated by the following pseudocode:

1: LRESULT_process_vkey(FUNC_DISPATCHHOOK hook_funk, DWORD vk_code, int
dw, WPARAM wParam, LPARAM lParam, HOOKPROC pfn)
2: {
3: if SystemKey(vk_code)
4: {
5: // if control button is pressed, than pass it to original hook
6: return hook_funk(dw, wParam, lParam, pfn);
7: }
8:
9: // otherwise, skip this evenet
10: return 0;
11: }
12:
13: LRESULT_process_message(FUNC_DISPATCHHOOK hook_funk,
PMSG msg_struct, int dw, WPARAM wParam, LPARAM lParam, HOOKPROC pfn)
14: {
15: // filter messages that can contain information about pressed key
16: switch (msg_struct−>message)
17: {
18: case WM_CHAR:
19: case WM_DEADCHAR:
20: case WM_SYSCHAR:
21: case WM_SYSDEADCHAR:
22: case WM_MENUCHAR:
23: case WM_IME_CHAR:
24: break;
25: case WM_VKEYTOITEM:
26: case WM_CHARTOITEM:
27: return_process_vkey(hook_funk, LOWORD(wParam), dw, wParam,
lParam, pfn);
28: break;
29: case WM_KEYDOWN:
30: case WM_KEYUP:
31: case WM_SYSKEYDOWN:
32: case WM_SYSKEYUP:
33: case WM_IME_KEYDOWN:
34: case WM_IME_KEYUP:
35: return_process_vkey(hook_funk, wParam, dw, wParam, IParam,
pfn);
36: break;
37: default:
38: return hook_funk(dw, wParam, lParam, pfn);
39: break;
40: }
41: return 0;
42: }
43:
44:
45: LRESULT_process_hook(FUNC_DISPATCHHOOK hook_funk, int dw, WPARAM
wParam, LPARAM lParam, HOOKPROC pfn)
46: {
47: if (!ProtectionEnabled( ))
48: {
49: // protection is disabled, pass information to original hook
50: return hook_funk(dw, wParam, lParam, pfn);
51: }
52: else
53: {
54: switch (HIWORD(dw))
55: {
56: // these hooks does not contain information about keyboard
state
57: // −> pass them to original addresses
58: case WH_MOUSE:
59: case WH_MOUSE_LL:
60: case WH_FOREGROUNDIDLE:
61: case WH_SHELL:
62: return hook_funk(dw, wParam, lParam, pfn);
63:
64: // below hooks can be used by keyloggers
65: // −> filter them
66: case WH_CALLWNDPROC:
67: {
68: PCWPSTRUCT st;
69: st = (PCWPSTRUCT)lParam;
70: MSG msg;
71: msg.message = st−>message;
72: msg.lParam = st−>lParam;
73: msg.wParam = st−>wParam;
74: return_process_message(hook_funk, &msg, dw, wParam,
lParam, pfn);
75: break;
76: }
77: case WH_CALLWNDPROCRET:
78: {
79: PCWPRETSTRUCT st;
80: st = (PCWPRETSTRUCT)lParam;
81: MSG msg;
82: msg.message = st−>message;
83: msg.lParam = st−>lParam;
84: msg.wParam = st−>wParam;
85: return_process_message(hook_funk, &msg, dw, wParam,
lParam, pfn);
86: break;
87: }
88: case WH_CBT:
89: if (LOWORD(dw) != HCBT_KEYSKIPPED)
90: return hook_funk(dw, wParam, lParam, pfn);
91: break;
92: case WH_MSGFILTER:
93: case WH_SYSMSGFILTER:
94: case WH_GETMESSAGE:
95: {
96: PMSG st;
97: st = (PMSG)lParam;
98: return_process_message(hook_funk, st, dw, wParam,
lParam, pfn);
99: break;
100: }
101: case WH_JOURNALPLAYBACK:
102: case WH_JOURNALRECORD:
103: {
104: PEVENTMSG st;
105: st = (PEVENTMSG)lParam;
106: MSG msg;
107: msg.message = st−>message;
108: msg.lParam = st−>paramL;
109: msg.wParam = st−>paramH;
110: return_process_message(hook_funk, &msg, dw, wParam,
lParam, pfn);
111: break;
112: }
113: case WH_KEYBOARD:
114: {
115: MSG msg;
116: msg.message = WM_KEYDOWN;
117: msg.lParam = lParam;
118: msg.wParam = wParam;
119: return_process_message(hook_funk, &msg, dw, wParam,
lParam, pfn);
120: break;
121: }
122: case WH_KEYBOARD_LL:
123: {
124: PKBDLLHOOKSTRUCT st = (PKBDLLHOOKSTRUCT)lParam;
125: MSG msg;
126: msg.message = wParam;
127: msg.lParam = st−>flags;
128: msg.wParam = st−>vkCode;
129: return_process_message(hook_funk, &msg, dw, wParam,
lParam, pfn);
130: break;
131: }
132: case WH_DEBUG:
133: return 0;
134: break;
135: }
136: }
137: return 0;
138: }
139:
140: LRESULT MY_DispatchHookA(int dw, WPARAM wParam, LPARAM lParam,
HOOKPROC pfn)
141: {
142: return_process_hook(DynamicREAL_DispatchHookA, dw, wParam,
lParam, pfn);
143: }
144:
145: LRESULT MY_DispatchHookW(int dw, WPARAM wParam, LPARAM lParam,
HOOKPROC pfn)
146: {
147: return_process_hook(DynamicREAL_DispatchHookW, dw, wParam,
lParam, pfn);
148: }

As shown, after the dispatch routines are hooked (by _DispatchHookA and _DispatchHookW), the _process_hook function (definition beginning at line 45) examines hook events for hooks that can be used by key loggers (i.e., “switch” statement beginning at line 54). For example, the keyboard hook event (WH_KEYBOARD case arm) is trapped at line 113. If an event is not trapped (or if protection is disabled), the event is allowed to pass through normally (i.e., it is not trapped). Upon trapping of a hook event, such as WH_KEYBOARD, the _process_message function (definition beginning at line 13) is invoked to filter messages that can contain information about pressed key. For example, the WM_CHAR message is trapped (at line 18), and the message is effectively discarded by virtue of the “break” statement (at line 24). (WM_CHAR represents the message Windows ordinarily posts to the window with the keyboard focus when a WM_KEYDOWN message occurs; the WM_CHAR message contains the character code of the key that was pressed.) Thus in this matter, the anti-key logger system of the present invention may defeat key loggers that attempt to set Windows hooks.

Blocking GetAsyncKeyState( )/GetKeyboardState( )/GetKeyState( ) API Calls

The anti-key logger system includes a GetAsyncKeyState( )/GetKeyboardState( )/GetKeyState( ) API call blocker that provides a mechanism to block key loggers that use user space API to read keyboard state (i.e., reading which button is pressed). The anti-key logger system hooks these API calls so that whenever an application tries to invoke them, Windows (OS) reports the status that no key is pressed at the moment. Exemplary program logic for this functionality is illustrated by the following pseudocode:

1: BOOL WINAPI MY_GetKeyboardState(PBYTE IpKeyState)
2: {
3: if (ProtectionEnabled( ))
4: {
5: // reset information about pressed keys
6: memset(IpKeyState, 0, 256);
7: return FALSE;
8: }
9: else
10: {
11: // return original information
12: return REAL_GetKeyboardState(IpKeyState);
13: }
14: }
15:
16: SHORT_get_key_state(int vKey,
GET_KEY_STATE func_get_key_state)
17: {
18: if (ProtectionEnabled( ))
19: {
20: if (SystemKey(vKey))
21: {
22: // system key is pressed - pass this information to
application
23: return func_get_key_state(vKey);
24: }
25: }
26: else
27: return func_get_key_state(vKey);
28:
29: // by default, return 0 = no key is pressed
30: return 0;
31: }
32:
33:
34: SHORT WINAPI MY_GetKeyState(int vKey)
35: {
36: return_get_key_state(vKey, REAL_GetKeyState);
37: }
38:
39:
40: SHORT WINAPI MY_GetAsyncKeyState(int vKey)
41: {
42: return_get_key_state(vKey, REAL_GetAsyncKeyState);
43: }

As in the case of Windows DispatchHookEx( )/DispatchHookExW( ) described above, Windows GetAsyncKeyState( ), GetKeyboardState( ), and GetKeyState( ) API functions are hooked with corresponding _GetAsyncKeyState( ), _GetKeyboardState( ), and _GetKeyState( ) functions of the present invention. The first two of the functions in turn invoke the _get_key_state function (definition beginning at line 16). In the case that protection is enabled, the _get_key_state function simply reports that no key was pressed (line 30). However, in the currently preferred embodiment, system keys (e.g., CTRL, SHIFT, and ALT) are reported (lines 20-25). The _GetKeyboardState function (definition beginning at line 1) also suppresses keyboard state information, but does so in a slightly different manner. Specifically, the function simply overrides the keyboard state memory location (i.e., memory address pointed to by IpKeyState), using a memset operation (line 6).

Blocking SDT Hooks

The Service Descriptor Table (SDT) hooks blocker provides a mechanism to bypass kernel-mode hooks for WIN32 GUI calls. The SDT is a kernel-level system call table that lists addresses of the actual implementation of the operating system functions. Some key loggers hook SDT for Windows messaging API in the kernel space and monitor all messages received by the application (including messages generated by keyboard events). To bypass such key loggers, the SDT hooks blocker creates new a SDT table for Windows GUI calls and initializes it with the original API calls addresses. Original values for the SDT are taken from disk image of WIN32K.SYS (GUI subsystem of the Windows NT kernel). Exemplary program logic for this functionality is illustrated by the following pseudocode:

1: // create new SDT table with addresses passed from user space
2: static NTSTATUS set_table(PUCHAR inbuf, ULONG inlen)
3: {
4: // find pointer to existent table
5: g_shadow_table =
(PSERVICE_DESCRIPTOR_TABLE)find_shadow_table( );
6:
7: // verify data passed from userspace
8: verify_table((PULONG)inbuf, g_shadow_table[1].TableSize,
&result);
9:
10: // initialize new SDT with values from system SDT
11: memcpy(g_service_table, inbuf,
4*g_shadow_table[1].TableSize);
12:
13: // initialize new SDT with new values of WIN32 GUI calls (passed
from userspace)
14: memcpy(g_local_table, g_shadow_table, sizeof(g_local_table));
15: g_local_table[1].ServiceTable = g_service_table;
16:
17: return 0;
18: }
19:
20: // protect thread (assign new SDT to it)
21: static NTSTATUS hook_thread(ULONG tid)
22: {
23: ULONG* ethread;
24: PsLookupThreadByThreadId((PVOID)tid,
(PETHREAD*)&ethread));
25: ethread[service_table_offset] = (ULONG)g_local_table;
26: return STATUS_SUCCESS;
27: }
28:
29: // unprotect thread (assign default system SDT)
30: static NTSTATUS unhook_thread(ULONG tid)
31: {
32: ULONG* ethread;
33: PsLookupThreadByThreadId((PVOID)tid,
(PETHREAD*)&ethread));
34: ethread[service_table_offset] = (ULONG)g_shadow_table;
35: return STATUS_SUCCESS;
36: }

As shown, the set_table function (definition beginning at line 2) creates a new SDT table with addresses passed in from the user space. The function first obtains a pointer to the existing table (at line 5). The new SDT is initialized with values from system SDT, using a memory operation (line 11). Now, the table can be filled with new SDT values of WIN32 GUI calls passed from user space (shown at line 14). The hook_thread function (definition beginning at line 21) protects threads by assigning the new SDT to it (i.e., threads invoke OS API services pointed to by the new SDT). The hook_thread function is invoked with a thread ID (tid) parameter. This allows the function to perform a look-up using the Windows PslookupThreadByThreadID function (exported by Windows NTOSKRNL). From the look-up, the function obtains a thread object (Windows _ETHREAD struct) pointer (line 24), a Windows construct fully characterizing the thread. Now, the function can index into the thread object (i.e., at service_table_offset), for assigning the new SDT (i.e., overwriting the existing value of the service table field of the thread object with a value pointing to the new SDT). A thread is unprotected by the complimentary unhook_thread function (definition beginning at line 30). The unhook_thread function basically reverses the protection process, by reassigning the default system SDT back into the thread object (at line 34).

Process Creation Monitor

The process creation monitor provides a mechanism to track all starting processes. Some key loggers can be started after protection has been enabled. To catch this situation, the anti-key logger of the present invention monitors all starting processes (by monitoring Windows CreateProcess functions) and injects its protection module into the context of each newly-created process. The Windows CreateProcess API functions create a new process and its primary thread. The new process runs the specified executable file in the security context of the calling process. (Windows CreateProcessW is the Unicode version of this function; CreateProcessA is the ANSI version.) Exemplary program logic for this functionality is illustrated by the following pseudocode:

1: // hooked version of CreateProcessW
2: BOOL WINAPI MY_CreateProcessW(LPCWSTR
IpApplicationName,
3: LPWSTR IpCommandLine,
4: LPSECURITY_ATTRIBUTES IpProcessAttributes,
5: LPSECURITY_ATTRIBUTES IpThreadAttributes,
6: BOOL bInheritHandles,
7: DWORD dwCreationFlags,
8: LPVOID IpEnvironment,
9: LPCWSTR IpCurrentDirectory,
10: LPSTARTUPINFOW IpStartupInfo,
11: LPPROCESS_INFORMATION IpProcessInformation)
12: {
13: PWCHAR dIls[l];
14: dIls[0] = _wide_dIl_full_name;
15:
16: // create new process with injected icsak.dIl
17: return create_process_with_dIl_w(IpApplicationName,
18: IpCommandLine,
19: IpProcessAttributes,
20: IpThreadAttributes,
21: bInheritHandles,
22: dwCreationFlags,
23: IpEnvironment,
24: IpCurrentDirectory,
25: IpStartupInfo,
26: IpProcessInformation,
27: dIls,
28: l,
29: REAL_CreateProcessW);
30: }
31:
32: // hooked version of CreateProcessA
33: BOOL WINAPI MY_CreateProcessA(LPCSTR IpApplicationName,
34: LPSTR IpCommandLine,
35: LPSECURITY_ATTRIBUTES IpProcessAttributes,
36: LPSECURITY_ATTRIBUTES IpThreadAttributes,
37: BOOL bInheritHandles,
38: DWORD dwCreationFlags,
39: LPVOID IpEnvironment,
40: LPCSTR IpCurrentDirectory,
41: LPSTARTUPINFOA IpStartupInfo,
42: LPPROCESS_INFORMATION IpProcessInformation)
43: {
44: PCHAR dIls[l];
45: dIls[0] = _ansi_dIl_full_name;
46:
47: // create new process with injected icsak.dIl
48: return create_process_with_dIl_a(IpApplicationName,
49: IpCommandLine,
50: IpProcessAttributes,
51: IpThreadAttributes,
52: bInheritHandles,
53: dwCreationFlags,
54: IpEnvironment,
55: IpCurrentDirectory,
56: IpStartupInfo,
57: IpProcessInformation,
58: dIls,
59: l,
60: REAL_CreateProcessA);
61: }
62:
63:
64: BOOL APIENTRY DIlMain( HANDLE hModule,
65: DWORD ul_reason_for_call,
66: LPVOID IpReserved
67: )
68: {
69: switch (ul_reason_for_call)
70: {
71: case DLL_PROCESS_ATTACH:
72: GetModuleFileName(
73: (HMODULE)hModule,
74: _ansi_dIl_full_name,
75: sizeof(_ansi_dIl_full_name));
76: break;
77: }
78: return TRUE;
79: }

As shown, replacements (hooked functions) for Windows CreateProcessW and CreateProcessA are provided. For example, the replacement _CreateProcessW function (definition beginning at line 2) invokes the helper routine create_process_with_dll_w (at lines 48-60) to create the requested new process but in a manner that first injects the ALK engine (icsak.dll). In this manner, key loggers started after protection has been enabled can also be thwarted.

While the invention is described in some detail with specific reference to a single-preferred embodiment and certain alternatives, there is no intent to limit the invention to that particular embodiment or those specific alternatives. For instance, while the currently preferred embodiment has been described in terms of security breaches involving unauthorized recording or logging of keystrokes (“key logging”), those skilled in the art will appreciate that the system and methodologies described herein may be adapted for other user input (e.g., mouse input, speech input, or the like). Therefore, those skilled in the art will appreciate that certain modifications may be made to the preferred embodiment without departing from the teachings of the present invention.

What is claimed is:

1. A method for protecting a computer system from security breaches that include unauthorized logging of user input, the method comprising:
specifying a particular application to be protected from unauthorized logging of user input;
identifying additional system processes that may serve as a source of unauthorized logging of user input;
injecting into the particular application and each identified system process an engine capable of detecting and blocking attempts at unauthorized logging of user input; and
upon detection of an attempt at unauthorized logging of user input, blocking the attempt so that user input for said particular application remains protected from unauthorized logging.

2. The method of claim 1, wherein said additional system processes include system processes running in user mode that may be a source of unauthorized logging of user input.

3. The method of claim 1, further comprising:
loading a driver capable of detecting and blocking attempts at unauthorized logging of user input that originate from processes running in kernel mode.

4. The method of claim 1, further comprising:
monitoring creation of new processes on the computer system, for detecting the creation of any new process that attempts unauthorized logging of user input.

5. The method of claim 1, wherein said blocking step includes:
monitoring application programming interfaces (APIs) that may be used for unauthorized logging of user input, and blocking any detected attempt to use said APIs for unauthorized logging of user input.

6. The method of claim 1, wherein said particular application is protected against unauthorized logging of user input when current input focus is set to the particular application.

7. The method of claim 1, wherein said engine is implemented as a dynamic link library (DLL) and said injecting step includes:
loading an instance of the DLL into a memory context for the particular application and for each identified system process.

8. The method of claim 1, wherein said particular application comprises a browser that is converted into a secured browser that is protected against unauthorized logging of user input.

9. The method of claim 8, further comprising:
disabling protection in response to a user's request, whereupon the secured browser reverts back to an unprotected browser.

10. The method of claim 1, wherein said user input includes keystroke input.

11. A computer-readable medium having processor-executable instructions for performing the method of claim 1.

12. A system for protecting a computer from unauthorized logging of user input, the system comprising:
application software that is desired to be protected from unauthorized logging of user input;
a first module for protecting said application software from unauthorized logging of user input, wherein said first module blocks attempts at unauthorized logging from processes that run on the computer system in user mode; and
a second module for blocking attempts at unauthorized logging from processes running in kernel mode.

13. The system of claim 12, wherein said system monitors creation of new processes on the computer, for detecting the creation of any new process that attempts unauthorized logging of user input.

14. The system of claim 12, wherein said system monitors application programming interfaces (APIs) that may be used for unauthorized logging of user input, and blocks any detected attempt to use said APIs for unauthorized logging of user input.

15. The system of claim 12, wherein said application software is protected against unauthorized logging of user input when current input focus is set to the application software.

16. The system of claim 12, wherein said first module is implemented as a dynamic link library (DLL) that is loaded into a memory context for the application software and for each system processes running in user mode on the computer.

17. The system of claim 12, wherein said application software serves as a secured browser protected against unauthorized logging of user input, when said system is activated.

18. The system of claim 17, wherein upon disabling of protection in response to a user's request, the secured browser reverts back to an unprotected browser.

19. The system of claim 12, wherein said user input includes keystroke input.

20. The system of claim 12, wherein said first module comprises an anti-key logging engine operating in user mode on the computer.

21. The system of claim 12, wherein said second module comprises an anti-key logging driver operating in kernel mode on the computer.

22. The system of claim 12, wherein said first module hooks application programming interface (API) calls that may be exploited by unauthorized software for logging user input.

23. The system of claim 22, wherein said first module hooks API calls by modifying corresponding function entry points in the computer's operating system.

24. The system of claim 22, wherein said first module masks input events such that said unauthorized software is unable to log user input using said API calls.

25. In a computer system, an improved method for preventing theft of sensitive information, the method comprising:
authorizing a process running on the computer system to receive sensitive information provided via user input;
trapping user input events occurring on the computer system before they are reported to processes running on the computer system;
allowing the user input events to be passed through to the authorized process; and
masking the user input events from other processes running on the computer system that have not been authorized.

26. The method of claim 25, wherein the authorized process comprises a browser application secured for receiving input of sensitive information.

27. The method of claim 25, wherein the user input events are masked from other processes only when the authorized process has current focus for receiving user input.

28. The method of claim 25, wherein said trapping step includes:
hooking application programming interface (API) calls that may be used by unauthorized logging software, such that unauthorized logging software is prevented from using said API calls for obtaining sensitive information provided via user input.

29. The method of claim 25, wherein said trapping step includes:
modifying function entry points in the computer's operating system that may be exploited for logging user input.

30. The method of claim 29, wherein said modifying step includes:
modifying entry points for functions in the computer's operating system that allow processes to register hooks for receiving user input events.

31. The method of claim 29, wherein said modifying step includes:
modifying entry points for functions in the computer's operating system that allow processes to inquire about user input state information.

32. The method of claim 25, wherein said trapping step includes:
injecting an engine into said authorized process and into other selected processes, for monitoring and processing user input events.

33. The method of claim 32, wherein said selected processes include system processes operating in user mode.

34. The method of claim 25, wherein said trapping step includes:
installing a driver that attaches a filter that disables kernel-mode loggers from logging sensitive information provided as user input.

35. The method of claim 34, wherein said driver functions to bypass other device drivers that could potentially be unauthorized logger devices.

36. An anti-key logging system for preventing unauthorized logging of user input from a computer, the anti-key logging system comprising:
program logic for intercepting user input events occurring on the computer before such events are reported to processes running on the computer;
program logic for reporting the user input events to a process specifically authorized to receive the user input events; and
program logic for blocking the user input events from other processes running on the computer that have not been authorized.

37. The system of claim 36, wherein the authorized process comprises a browser application secured for receiving input of sensitive information.

38. The system of claim 36, wherein the user input events are blocked from other processes only when the authorized process has current focus for receiving user input.

39. The system of claim 36, wherein said program logic for intercepting includes:
program logic for hooking application programming interface (API) calls that may be employed by unauthorized logging software, such that unauthorized logging software is prevented from using said API calls for obtaining sensitive information provided via user input.

40. The system of claim 36, wherein said program logic for intercepting includes:
program logic for modifying function entry points in the computer's operating system that may be exploited for logging user input.

41. The system of claim 36, wherein said program logic for intercepting includes:
program logic for modifying entry points for functions in the computer's operating system that allow processes to register hooks for receiving user input events.

42. The system of claim 36, wherein said program logic for intercepting includes:
program logic for modifying entry points for functions in the computer's operating system that allow processes to query state information about user input.

43. The system of claim 36, wherein said program logic for intercepting includes:
engine logic, injected into said authorized process and into other selected processes, for monitoring and processing user input events.

44. The system of claim 43, wherein said selected processes include system processes operating in user mode.

45. The system of claim 36, wherein said program logic for intercepting includes:
a filter that disables kernel-mode loggers from logging sensitive information provided via user input.

46. The system of claim 45, wherein said filter causes the computer to bypass device drivers that could potentially be unauthorized logger devices.
